(19) United States
(12) Patent Application Publication
(10) Pub. No.: US 2014/0122977 A1
(43) Pub. Date: May 1, 2014

(54) VARIABLE CONTROL FOR A FORWARD ERROR CORRECTION CAPABILITY

(71) Applicants: Peter Alexander Carides, San Diego, CA (US); Barry R. Robbins, Carlsbad, CA (US)

(72) Inventors: Peter Alexander Carides, San Diego, CA (US); Barry R. Robbins, Carlsbad, CA (US)

(21) Appl. No.: 13/834,212

(22) Filed: Mar. 15, 2013

Related U.S. Application Data
(60) Provisional application No. 61/721,397, filed on Nov. 1, 2012.

(51) Int. Cl. H04L 1/00

(52) U.S. Cl. CPC H04L 1/0072
USPC 714/776

(57) ABSTRACT

A system and method are disclosed for allowing a user at the transmit end of a communication link to change a forward error correction scheme to select between relatively high spectral efficiency and relatively small error block processing delay. The system can include a modem having a plurality of encoding modules, at least one modulation module and a user input module. Pluralities of switches are provided to selectively route an input data-stream to one of the encoding modules. The switches are operationally coupled with the user input module allowing the user to route the input data-stream to a user-selected encoding module. At the user-selected encoding module, the input data-stream is processed to add an FEC redundancy and output FEC blocks having an FEC block size that is unique to the selected encoding module. In this way, the user selects the different encoding modules and the corresponding different FEC block sizes.

This application claims the benefit of U.S. Provisional Patent application Ser. No. 61/721,397, titled “VARIABLE CONTROL FOR A FORWARD ERROR CORRECTION CAPABILITY,” filed Nov. 1, 2012. The entire contents of Application Serial No. 61/721,397 are hereby incorporated by reference herein.

### FIELD OF THE INVENTION

The present invention pertains generally to systems and methods for controlling errors in data transmissions. More particularly, the present invention pertains to systems and methods for controlling errors in data transmissions using forward error correction (FEC) techniques. The present invention is particularly, but not exclusively, useful as a system and method for controlling errors in data transmissions while selectively optimizing spectral efficiency and error block processing delay.

### BACKGROUND OF THE INVENTION

Data transmission over noisy or otherwise unreliable communication channels can result in the corruption of data and the consequent receipt of erroneous data. Early attempts to overcome the drawbacks associated with imperfect communication channels required re-transmission of erroneous data. Specifically, at the receive end of the channel, erroneous data was detected and a request was communicated to the sender to re-transmit some or all of the data in the original transmission. This process of re-transmitting data, in addition to requiring a reverse communication channel for the re-transmission request, is inefficient and greatly reduces the overall transmission rate of the forward communication channel.

Modernly, forward error correction (FEC) techniques have been available to eliminate the need for re-transmission of erroneous data. These FEC techniques can involve adding a redundancy to the data prior to transmission. In simple terms, an increase in the amount of redundancy increases the probability of successfully recovering the faulty data at the cost of increasing the total data that must be transmitted. This latter concept is often quantified in terms of a so-called “code rate”, “k/n”, where “k” is the original, non-redundant useful data and “n” is the combined data including the original, non-redundant useful data and the redundant data.

Typically, for FEC techniques, the redundant data is encoded with the useful data using an encoding module that is included as part of a modem. The encoded data is then modulated on a carrier wave at the modem and transmitted over the link.

One of the challenges faced in the design of a modern modem is the specification of the functional blocks to provide forward error correction (FEC). Once a type is selected, further enumeration and parameterization must be specified. Usually these specifications are made with an overriding objective of maximizing the spectral efficiency of the link. When this is the case, larger FEC block sizes are specified in order to optimize this spectral efficiency. Spectral efficiency can be defined as the transmitted data rate for a given frequency bandwidth, with units of (bits/sec)/Hz, for example.

Unfortunately, the larger the FEC block size is, the more buffering is required to collect the large bin of bits/symbols, and the more processing is required to use the large block size specified in FEC scheme for preparing original data for transmission over noisy channel. This is true on both sides of the link, both the encoding module at the transmitting modem, and the decoder at the receiving modem. This large block size buffering and processing results in significantly increased processing delay or latency. There are some applications, however, where maximal spectral efficiency is less important than minimizing the processing delay or latency. There are also applications where minimizing the processing delay or latency is less important than maximal spectral efficiency.

In light of the above, it is an object of the present invention to provide systems and methods for allowing a user at the transmit end of a communication link to change the FEC block size to select an appropriate spectral efficiency and error block processing delay. It is another object of the present invention to provide systems and methods for allowing a user to modify an FEC block size for a transmission based on information regarding available system bandwidth and/or an outside requirement on the data transfer rate and/or checking the number of error bits corrected at the decoder and/or making a decision from lookup table based on channel estimation. Yet another object of the present invention is to provide a Variable Control for a Forward Error Correction Capability and corresponding methods of use which are easy to use, relatively simple to implement, and comparatively cost effective.

### SUMMARY OF THE INVENTION

In accordance with the present invention, a system for allowing a user at the transmit end of a communication link to change a forward error correction scheme and change the block size associated with that FEC scheme includes a modem. For the system, the modem includes a plurality of encoding modules, at least one modulation module and a user input module.

In more detail, the encoding modules are arranged to receive an input data-stream from a modem input port. Pluralities of switches are provided to selectively route the input data-stream to one of the encoding modules. The switches, in turn, are operationally coupled with the user input module allowing the user to route the input data-stream to a user-selected encoding module.

At the user-selected encoding module, the input data-stream is processed to add an FEC redundancy and output FEC blocks having an FEC block size that is unique to the selected encoding module. Each encoding module outputs FEC blocks having different FEC schemes and different FEC block sizes. In this way, the user selects the encoding module and the corresponding FEC block size.

The output of the selected encoding module is modulated on a carrier signal by the modulation module and the modulated carrier signal is communicated to a modem output port. From the output port, the modulated carrier signal can be communicated over a link such as a wireless satellite communication link. The signal can then be received by one or more receivers having a modem for decoding the FEC blocks.

To use the system, a user first receives information regarding spectral efficiency and/or an acceptable level of error block processing delay. For example, the user may obtain information regarding the communication link indicating that a particular level of spectral efficiency is required for a successful data transfer. In this case, the user can determine the corresponding FEC scheme and FEC block size providing the required spectral efficiency while limiting undesirable processing delay with the large block sizes.

On the other hand, limiting processing delay may be important. In particular, the user may receive information specifying a limit on processing delay for a successful data transfer. For this case, the user can determine the corresponding FEC block size ensuring the block processing delay is within acceptable limits while maximizing spectral efficiency as a second consideration.

In one embodiment, the user input module can include a software-selectable “knob” that the user can turn, in order to choose between, on one end of the scale high spectral efficiency/high latency, and at the other end of the scale lower spectral efficiency/low latency, or a middle position between the two extremes. This selection can be optimized depending on the requirements of a given application at a given time. This software knob setting then, in turn, internally sets the appropriate FEC block size (by selecting the appropriate encoding module) based on the user's selection.

### BRIEF DESCRIPTION OF THE DRAWINGS

The novel features of this invention, as well as the invention itself, both as to its structure and its operation, will be best understood from the accompanying drawings, taken in conjunction with the accompanying description, in which similar reference characters refer to similar parts, and in which:

FIG. 1 depicts an operational environment for the present invention;

FIG. 2 shows a system for transmitting a data-stream over a communication link;

FIG. 3 is a simplified schematic of a modem for use in the present invention; and

FIG. 4 is a flowchart showing a process for using the system shown in FIG. 2.

### DESCRIPTION OF THE PREFERRED EMBODIMENTS

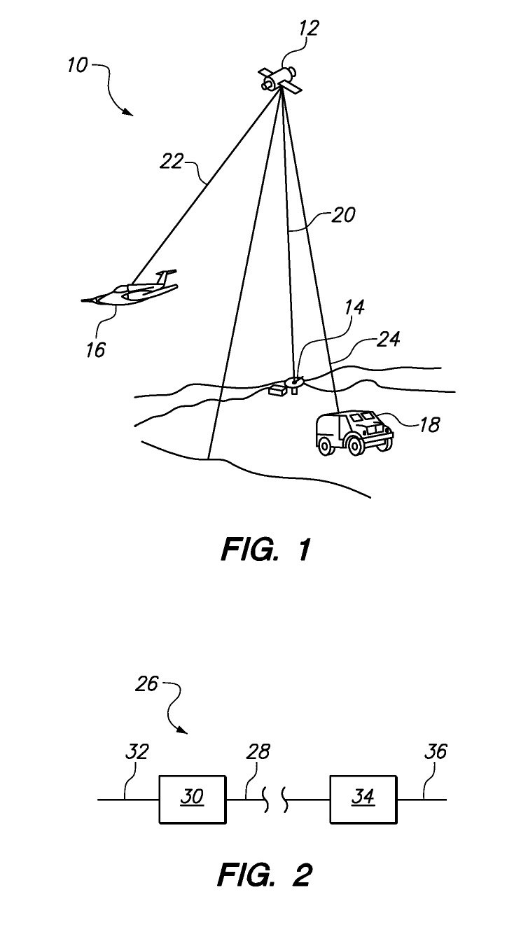

Referring initially to FIG. 1, an environment for implementing the present invention is shown and is generally designated 10. As shown, a satellite 12 can be used to establish a communication link with a ground station 14, aircraft 16 and terrestrial vehicle 18. Specifically, as shown, a link 20 is established between the satellite 12 and ground station 14, a link 22 is established between the satellite 12 and aircraft 16 and a link 24 is established between the satellite 12 and terrestrial vehicle 18. With this arrangement, the ground station 14, for example can send data to and receive data from the aircraft 16 via satellite 12.

FIG. 2 shows a system 26 for transmitting a data-stream over a communication link 28. For example, the system 26 shown in FIG. 2 can be used in the environment 10 of FIG. 1 to establish communication between the satellite 12, ground station 14, aircraft 16 and/or terrestrial vehicle 18. Continuing with FIG. 2, it can be seen that the system 26 includes a modem 30 for encoding and modulating an input data-stream 32 for transmission over the communication link 28 to a receiver 34. The receiver decodes and demodulates the transmission and produces an output data-stream 36.

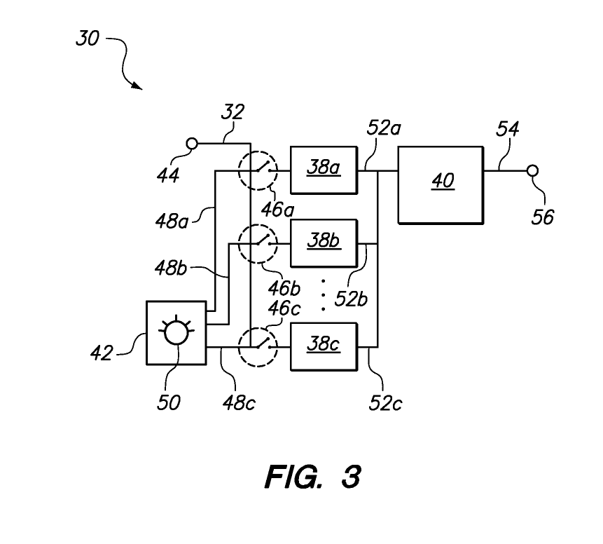

FIG. 3 shows an example embodiment of a modem 30 for use in the present invention. As shown, the modem 30 includes a plurality of encoding modules 38a-c, a modulation module 40 and a user input module 42. FIG. 3 also shows that the encoding modules 38a-c are arranged to receive an input data-stream 32 from a modem input port 44.

Continuing with FIG. 3, the modem 30 includes a plurality of switches 46a-c, with one switch 46a-c for each encoding module 38a-c. Although three encoding modules 38a-c are shown, it is to be appreciated that more than three and as few as two encoding modules 38a-c may be used for the modem 30. As shown, the switches 46a-c are arranged to selectively route the input data-stream 32 to one of the encoding modules 38a-c. Also, for the modem 30, the switches are controllable by the user input module 42 via control wires 48a-c, allowing the user to selectively open and close each of the switches 46a-c. In this manner, the user can route the input data-stream 32 to a user-selected encoding module 38a-c by operating a control 50 on the user input module. In one embodiment, the user input module 42 can include a software-selectable control 50 that the user can operate in order to choose between, on one end of the scale high spectral efficiency/high latency, and at the other end of the scale lower spectral efficiency/low latency, or a middle position between the two extremes. For this embodiment, the user input module can include a software equipped computer processor providing output controls signals to the switches 46a-c.

Once selected by the user, the user-selected encoding module 46a-c receives and processes the input data-stream 32 to add an FEC redundancy and provide an output 52a-c that includes FEC blocks of different block sizes. The FEC redundancy can be any type of FEC code/technique known in the pertinent art for use in data-stream transmission. For the modem 30, each encoding module 38a-c outputs FEC blocks having different FEC block sizes. In this way, the user selects the encoding module 38a-c and the corresponding FEC block size using the user input module 42.

FIG. 3 further shows that the output 52a-c of the selected encoding module 38a-c is modulated on a carrier signal by the modulation module 40 and the modulated carrier signal 54 is communicated to a modem output port 56. Cross referencing FIGS. 2 and 3, it can be seen that from the output port 56, the modulated carrier signal 54 can be communicated over a link 28 (which may include a satellite communication link component) to one or more receivers 34 having an internal modem for decoding the FEC encoded data.

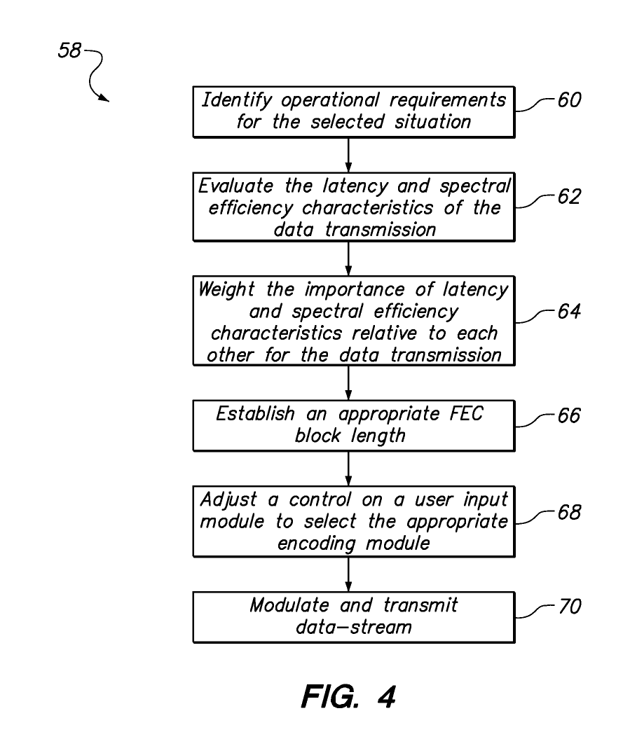

FIG. 4 shows a process 58 for using the system 26 (shown in FIG. 2). As seen there, the process begins identifying operational requirements for the selected situation (Step 60). For example, step 60 can include the user receiving information regarding spectral efficiency and/or an acceptable level of error block processing delay for the transmission of a data-stream 32 (FIG. 2). This information can include, in some instances, information from one or more network nodes indicating whether previously transmitted data were efficiently decoded (i.e. whether an FEC decoding capability specification was met for one or more previous transmissions). Also, as an example, the user may obtain information regarding the communication link indicating that a particular level of spectral efficiency is required for a successful data transfer. Alternatively, as another example, the user may receive information specifying a limit on processing delay (i.e. latency) for a successful data transfer.

Continuing with FIG. 4, it can be seen that once the information is received (step 60), the process 58 includes the step of evaluating the latency and spectral efficiency characteristics of the data transmission (step 62). In addition, as shown, the process 58 can include the step of weighting the importance of latency and spectral efficiency characteristics relative to each other for the data transmission (Step 64). Once the information has been evaluated and weighted, process 58 shows that an FEC block length can be established to accommodate the consequences of the evaluating and weighting steps (Step 66). With the FEC block length established, Step 68 shows that the user can adjust a control 50 (FIG. 3) on the user input 42 to select the appropriate encoding module 38a-c for transmission. Step 70 indicates that the data-stream is then modulated and transmitted.

While the particular Variable Control for a Forward Error Correction Capability as herein shown and disclosed in detail is fully capable of obtaining the objects and providing the advantages herein before stated, it is to be understood that it is merely illustrative of the presently preferred embodiments of the invention and that no limitations are intended to the details of construction or design herein shown other than as described in the appended claims.

What is claimed is:

1. A method for optimizing the spectral efficiency and latency of a data transmission, wherein the data is modulated/demodulated by a modem for a selected situation, the method comprising the steps of:
incorporating a Forward Error Correction (FEC) scheme into the modem, wherein the FEC scheme has a block length;
identifying operational requirements for the selected situation; and
varying the block length of the FEC scheme to establish a desired spectral efficiency and a correspondingly acceptable latency for the data transmission to satisfy the operational requirements of the selected situation.

2. A method as recited in claim 1 further comprising the steps of:
evaluating the latency and spectral efficiency characteristics of the data transmission;
weighting the importance of latency and spectral efficiency characteristics relative to each other for the data transmission; and
establishing a block length in the varying step to accommodate the consequences of the evaluating and weighting steps.

3. A method as recited in claim 1 wherein the modem comprises a user input module, a modulating module and a plurality of encoding modules.

4. A method as recited in claim 3 wherein each encoding module adds an FEC redundancy to the data and outputs FEC blocks of encoded data having an FEC block size that is different from the other encoding modules.

5. A method as recited in claim 3 wherein the user input module comprises a software-selectable control that the user can adjust to select between a high spectral efficiency/high latency block size, a low spectral efficiency/low latency block size, and at least one middle position therebetween.

6. A system for allowing a user at a transmit end of a communication link to set a forward error correction block size for a data-stream, the system comprising:
a plurality of encoding modules, each encoding module for adding an FEC redundancy to the data-stream and for outputting FEC blocks having a unique FEC block size;
a user input module allowing a user to select one of the encoding modules to encode the data-stream; and
at least one modulation module receiving an output from the selected encoding module and modulating the output onto a carrier signal for transmission over the communication link.

7. A system as recited in claim 6 further comprising a plurality of switches to selectively route the data-stream to one of the encoding modules in response to a control signal from the input module.

8. A system as recited in claim 6 wherein the user input module comprises a software-selectable control.

9. A system as recited in claim 8 wherein the software-selectable control is configured to allow the user to adjust the control to select between a high spectral efficiency/high latency block size, a low spectral efficiency/low latency block size and at least one middle position therebetween.

10. A system as recited in claim 8 further comprising at least one receiver positioned at a receive end of the transmission link, the receiver comprising a decoder.

11. A system as recited in claim 6 wherein the transmission link comprises a satellite communication link.

12. A system as recited in claim 6 wherein the plurality of encoding modules is at least three encoding modules.

13. A system as recited in claim 6 wherein outputs from the plurality of encoding modules are input to a common modulation module.

14. A modem for optimizing the spectral efficiency and latency of a data transmission, wherein the data is modulated/demodulated by the modem for a selected situation, the modem comprising:
a Forward Error Correction (FEC) block, wherein the FEC block has a block length; and
a means for varying the block length of the FEC block to establish a desired spectral efficiency and a correspondingly acceptable latency for the data transmission to satisfy the operational requirements of the selected situation.

15. A modem as recited in claim 14 wherein the means for varying the block length of the FEC block comprises a plurality of encoding modules.

16. A modem as recited in claim 15 wherein the means for varying the block length of the FEC block further comprises a plurality of switches to selectively route the data-stream to one of the encoding modules.

17. A modem as recited in claim 16 wherein the means for varying the block length of the FEC block further comprises a user input module operationally connected to the plurality of switches to selectively control the state of each switch.

18. A modem as recited in claim 17 wherein the user input module comprises a software-selectable control.

19. A modem as recited in claim 18 wherein the software-selectable control is configured to allow the user to adjust the control to select between a high spectral efficiency/high latency block size, a low spectral efficiency/low latency block size and at least one middle position therebetween.

20. A modem as recited in claim 19 wherein the plurality of encoding modules is at least three encoding modules.
